(19) United States
(12) Patent Application Publication
(10) Pub. No.: US 2025/0321175 A1
(43) Pub. Date: Oct. 16, 2025

(54) PORTABLE VISCOSITY MEASUREMENT DEVICE

(71) Applicant: United States Gypsum Company, Chicago, IL (US)

(72) Inventors: David Daniel PELOT, Chicago, IL (US); Charles Thomas BELL, Chicago, IL (US); Harsh Vipulbhai CHOKSHI, Darien, IL (US); Alfredo GARCIA, Cicero, IL (US); Mohamed Hisham Soliman Ahmed Ali HAGAR, Cairo (EG); Brennan Steven KEANE, Arlington Heights, IL (US)

(21) Appl. No.: 19/046,490

(22) Filed: Feb. 5, 2025

Related U.S. Application Data
(60) Provisional application No. 63/634,723, filed on Apr. 16, 2024.

(51) Int. Cl. G01N 11/14

(52) U.S. Cl. CPC G01N 11/14

(57) ABSTRACT

A handheld viscosity measurement device is provided and includes a housing including a drive shaft coupled to a motor, and a handle, a spindle attached to the drive shaft, a display device attached to the housing and a battery attached to the housing. In operation, the spindle is inserted in a material while the motor rotates the drive shaft and the spindle, the display device displays a measurement based on the resistance of the material on the spindle.

### BACKGROUND

The present invention relates generally to device for measuring the viscosity of different fluids, and more specifically, to a portable, handheld viscosity measurement device that is easily transported to remote locations to measure the viscosity of different fluids.

All fluids have a viscosity, which is a measure of a fluid's resistance to flow. More specifically, viscosity describes the internal friction of a moving fluid. For example, a fluid with large viscosity resists motion because its molecular makeup gives it a lot of internal friction, and a fluid with low viscosity flows easily because its molecular makeup results in very little friction when it is in motion.

The viscosity of fluids is commonly measured using a rheometer, which is a laboratory device used to measure the way in which a viscous fluid (a liquid, suspension or slurry) flows in response to applied forces Rheometers are designed to be placed on a tabletop or counter and include a spindle that is positioned in a fluid to measure the viscosity of that fluid. In operation, a motor is coupled to the spindle and causes the spindle to rotate within the fluid. The resistance of the fluid on the rotation of the spindle is measured by the rheometer and converted to a viscosity measurement. Although these devices are accurate, rheometers are bulky and have sensitive electronics such that they are not easily transported to remote locations for measuring the viscosity of fluids.

Furthermore, when a material is mixed on a job site and the material has one viscosity, but then the material is packaged, shipped, reopened, and tested at a laboratory, the material will have a different viscosity or can be in a new state since the material evolved since the time of mixing. The evolution of a material can also occur due to thixotropy, chemical reaction, or bioactivity.

Thixotropy occurs in materials that thin or thicken due to mixing or lack thereof. Chemical reactions can occur by the mixing of two parts on the jobsite or by the addition of a liquid, such as water. These reactive materials would be impossible to send back to a laboratory to test. Bioactivity can alter the viscosity as microorganisms interact with the fluid environment by changing molecular lengths, altering pH, etc. Being able to measure the viscosity of the material at the time when it is being used solves the evolving viscosity issue.

This also helps when practitioners have different methods of preparing the fluid for use. The methods of preparing and mixing the fluid can result in a different viscosity either due to the fluid or air entrainment. There are different parameters when preparing a fluid to be used, such as mixing speed, geometry, fill height, and time of mixing. Being able to measure the viscosity immediately after the mixing process provides information that could not be obtained using a fixed laboratory style rheometer.

Therefore, there is a need for a viscosity measurement device that is easily transported to remote locations for measuring the viscosity of different fluids at the remote locations.

### SUMMARY

The above-listed need is met or exceeded by the present viscosity measurement device, which is a handheld device that is easily portable to different locations to measure a viscosity of different materials, such as liquids, suspensions and slurries.

In an embodiment, a handheld viscosity measurement device is provided and includes a housing including a drive shaft coupled to a motor, and a handle, a spindle attached to the drive shaft, a display device attached to the housing and a removable and rechargeable battery attached to the housing. In operation, the spindle is inserted in a material while the motor rotates the drive shaft and the spindle, the display device displays a measurement based on the resistance of the material on the spindle.

In another embodiment, a handheld viscosity measurement device is provided and includes a housing including a drive shaft coupled to a motor, a display device and a handle, a spindle removably attached to the drive shaft, an activation button movably attached to the housing, a removable and rechargeable battery attached to the housing and a control unit inside the housing and in communication with the motor and the display device, where when a user inserts the spindle in a material and presses the activation button, the control unit causes the motor to rotate the drive shaft and the spindle, detect the electrical current of the motor and display the detected current on the display device.

### BRIEF DESCRIPTION OF THE DRAWINGS

FIG. 1 is a perspective view of an embodiment of the present viscosity measurement device;

FIG. 2A is a side perspective view of the viscosity measurement device of FIG. 1 with the spindle removed;

FIG. 2B is a rear view of another embodiment of the viscosity measurement device showing a rear display device;

FIG. 3 is a side view of an embodiment of the spindle of the viscosity measurement device of FIG. 1;

FIG. 4 is a side view of the viscosity measurement device of FIG. 1 with a portion of the housing removed; and

FIG. 5 is a perspective view of the viscosity measurement device of FIG. 1 being used to measure a viscosity of a material in a container.

FIG. 6 is a perspective view of another embodiment of the viscosity measurement device.

### DETAILED DESCRIPTION

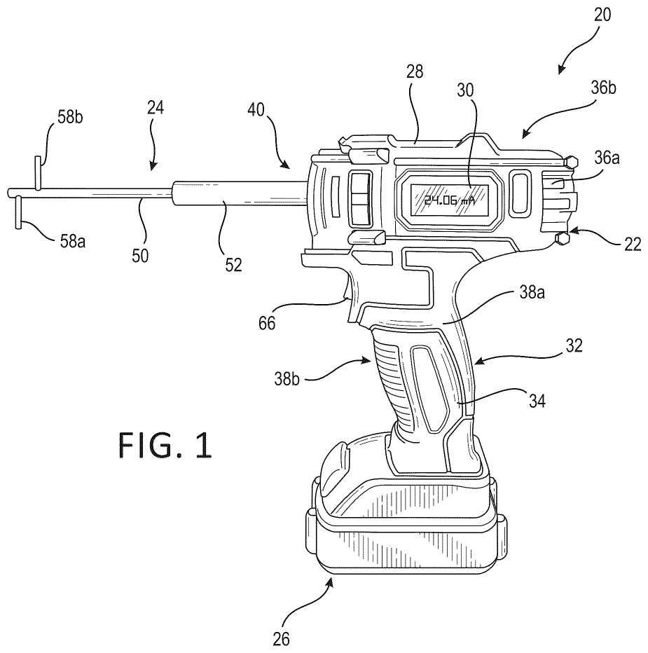

Referring to FIGS. 1, 2A, 2B and 3, an embodiment of the present viscosity measurement device 20 is shown where the viscosity measurement device 20 is a portable, handheld device that includes a housing 22, a spindle 24 removably attached to the housing 22 and a battery 26 removably attached to the housing. The housing 22 includes an upper member 28 having a display device 30, and a handle 32 attached to the upper member 28 where a longitudinal axis LA1 of the upper member 28 is substantially transverse to a longitudinal axis LA2 of the handle 32. The handle 32 has a peripheral surface 34 having an outer circumference that enables a person to grab and hold the handle. In an embodiment, the upper member 28 and the handle 32 each have two halves where a first half 36a of the upper member 28 and a first half 38a of the handle 32 and the second half 36b of the upper member 28 and the second half 38b of the handle 32 are integrally formed together in a mold and the first halves 36a, 38a and the second halves 36b, 38b of the upper member and the handle are connected together in a snap-fit type connection or by fasteners. A bottom end of the handle has a substantially flat surface with one or more electrical contacts.

In the illustrated embodiment, the battery 26 is removably attached to the bottom end of the handle 32. The battery 26 has one or more electrical contacts that align with and engage corresponding electrical contacts on the bottom end of the handle 32. In an embodiment, the battery 26 is a rechargeable battery that is removed and attached to a charger. After being re-charged, the battery 26 is re-attached to the bottom end of the handle 32. In an embodiment, the battery 26 includes a temporary locking mechanism to securely hold the battery on the handle where the battery is released by pressing a button or similar device on the locking mechanism.

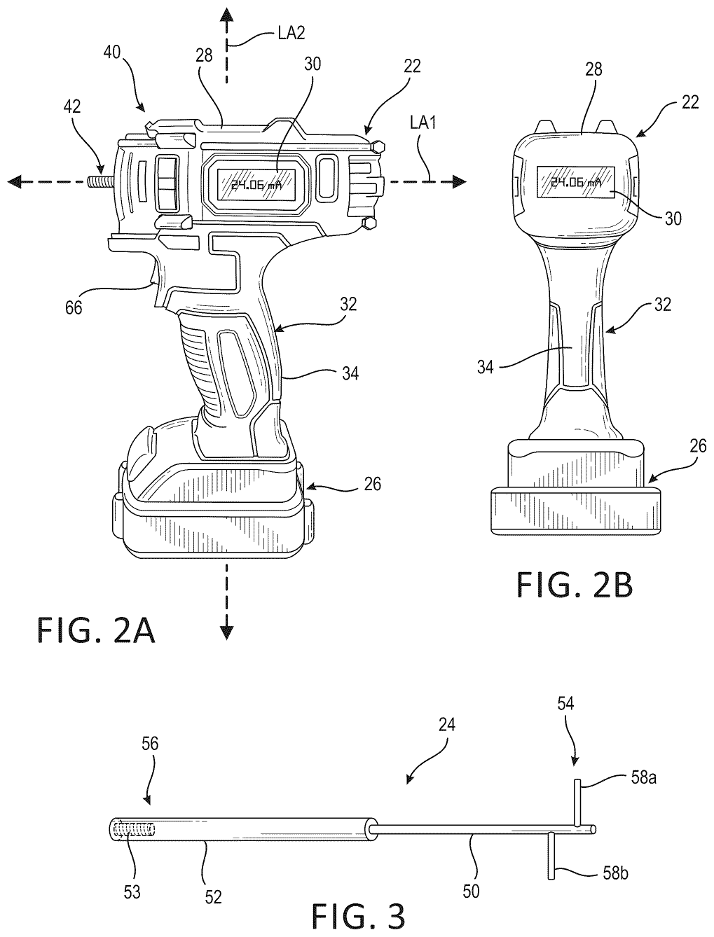

As shown in FIGS. 1 and 2A, a front end 40 of the housing 22 includes a drive shaft 42 having a first end 44 that extends outwardly from the front end 40 of the housing 22 and an opposing second end 46 that is coupled to a motor 48 secured within the housing 22. A portion of the first end 44 of the drive shaft 42 has threads formed on an outer surface of the drive shaft. The spindle 24 includes a shaft 50 with a connecting member 52 having a bore 53 (FIG. 3) with internal threads. The spindle 24 is connected to the first end 44 of the drive shaft 42 by threading the connecting member 52 of the spindle 24 onto the first end of the drive shaft. It should be appreciated that the spindle 24 may be connected to the drive shaft by a twist-type connection, a snap-fit connection or by any suitable connection or attachment method. In operation, the motor 48 receives power from the battery 26, which causes the drive shaft 42 to rotate, and simultaneously causes the spindle 24 to rotate.

Referring to FIG. 3, an embodiment of the spindle 24 is shown where the spindle has a first end 54 and an opposing second end 56. As described above, the second end 56 of the shaft 50 includes the connecting member 52, which is removably connected to the drive shaft 42. In the illustrated embodiment, a diameter of the connecting member 52 is greater than a diameter of the shaft 50 to provide rigidity and support to the shaft at the second end 56. It should be appreciated that the spindle 24 may have a uniform diameter or a plurality of different diameters. As shown in FIG. 3, the first end 54 of the spindle 24 includes resistance members 58a and 58b that extend in opposite directions. In an embodiment, the resistance members 58a, 58b have the same size and shape and are offset from each other, i.e., spaced from each other along the longitudinal axis of the spindle 24. In another embodiment, the resistance members 58a, 58b are at the same location on the spindle 24 and are located at the outermost end of the spindle 24. In a further embodiment, the resistance members 58a, 58b are at the same location on the spindle and are located between the first end 54 and the second end 56 of the spindle 24. It should be appreciated that the resistance members 58a, 58b may be the same size and shape or have a different size and/or shape. Further, the spindle 24 may have two resistance members as shown in FIG. 3 or a plurality of resistance members that are located at a common location or different locations along the longitudinal axis of the spindle 24. In the illustrated embodiment, the spindle 24 including the resistance members 58a, 58b is made of metal, such as stainless steel. It should be appreciated that the spindle 24 may be made with a composite material or any suitable material or combination of materials. In another embodiment, the spindle may be an ASTM spindle, vane-type spindle, cylindrical spindle or any suitable spindle.

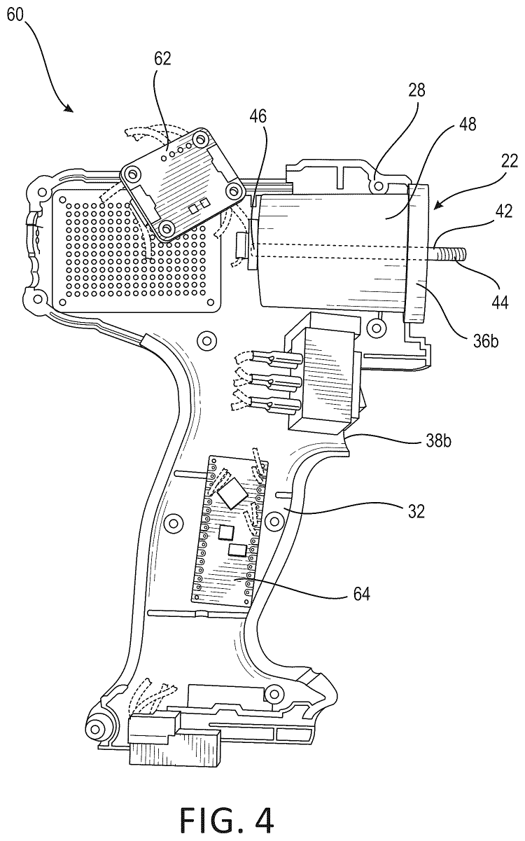

Referring to FIG. 4, the interior of the housing 22 includes the motor 48, the drive shaft 42 coupled to the motor 48 and a control unit 60 comprising a first circuit board 62, a second circuit board 64 and a switch or activation button 66 that are connected together by electrical wiring 68. In an embodiment, the display device 30 is mounted to a side of the upper member 28 of the housing 22 as shown in FIG. 2A and is electrically coupled to the first circuit board 62. In another embodiment shown in FIG. 2B, the display device 30 is attached to an end of the upper member 28 of the housing 22 where the end is opposite to the end including the drive shaft 42. Thus in this embodiment, the display device 30 is facing and readily visible by a user when the viscosity measurement device 20 is being used to measure a viscosity of a material. The second circuit board 64 is coupled to the activation button 66, which enables a user to press the button 66 to activate the viscosity measurement device 20. In the above embodiments, the control unit 60 may be a controller, a processor or any suitable processing device.

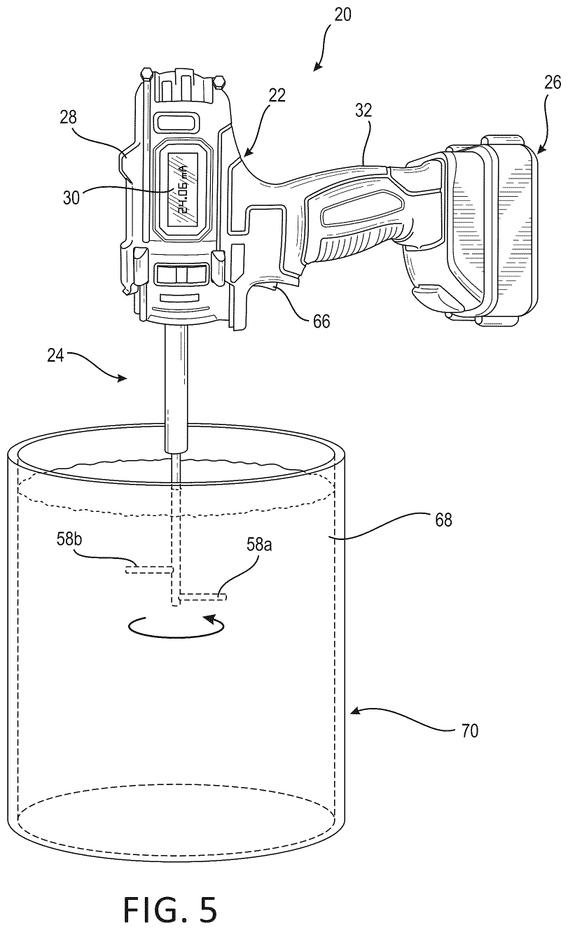

Referring to FIG. 5, the handheld viscosity measurement device 20 is transported to a remote location and inserted in a material 68, such as a liquid, suspension or slurry, which is in a container 70 or in another area. A user then presses the button 66 to activate (turn on) the viscosity measurement device 20, which causes the motor 48 to rotate the drive shaft 42 and simultaneously rotate the spindle 24 at a predetermined rotational speed measured in revolutions per minute (rpm). As the spindle 24 rotates, the material 68 resists the rotation of the resistance members 58a, 58b on the spindle 24. The greater the viscosity of the material, the greater the resistance or resistance force that is applied to the resistance members 58a, 58b.

In operation, the motor 48 is configured to rotate at a designated rotational speed (rpm). For example, in an embodiment, the motor 48 is configured to rotate at a rotational speed of 75 revolutions per minute. It should be appreciated that the motor 48 may be configured to rotate in a clockwise direction or in a counter clockwise direction and at any suitable rotational speed or at different rotational speeds. In use, as the resistance applied to the resistance members 58a, 58b by the material increases, the motor 48 requires more power, i.e., electrical current (amps), to maintain the designated rotational speed of the motor. The control unit 60 measures and displays the electrical resistance in amps used by the motor 48 on the display device 30, where the measured or detected amps is converted to a viscosity measurement of the material. For example, the display device in FIG. 2B displays the detected amps of the motor as 24.06 milliamps (mA), which is then converted to a viscosity by the control unit or by the user. The display device is configured to display an electrical resistance, a motor torque and/or a viscosity based on the spindle used and the rotational speed of the spindle. The handheld viscosity measurement device 20 is therefore easily portable, such as by hand or in a case or backpack, to different locations to measure the viscosity of one or more materials at those locations. In this way, the viscosity measurement device 20 saves substantial time and money in measuring viscosities of different materials in remote locations over conventional measurement techniques, where the viscosities of the materials would have to be measured in a laboratory or facility using a rheometer or similar device.

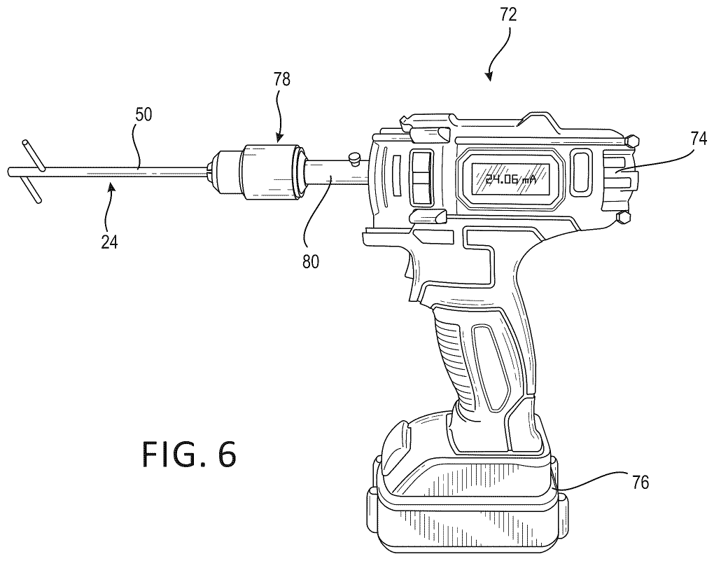

Referring to FIG. 6, another embodiment of the viscosity measurement device is shown where the viscosity measurement device 72 includes a housing 74 and a battery 76 as described above, and a chuck 78 attached to drive shaft 80 coupled to the motor inside the housing. The chuck 78 is a type of clamp used to hold and secure the spindle 24, and is configured to grip the shank or shaft 50 of the spindle, which is the portion of the spindle that fits into an opening in the chuck. In the illustrated embodiment, the chuck 78 includes internal jaws (not shown) that grip the shaft 50 of the spindle 24, and a key (not shown) that fits into a corresponding key hole on the chuck, where the key is turned within the key hole to tighten or loosen the jaws relative to the shaft 50 of the spindle 24. When the chuck 78 is opened, the jaws will open wide enough to receive the shaft 50 of spindle 24. As the chuck 78 is tightened using the key, the jaws will close in and grip the shaft 50 of the spindle 24, to firmly secure the spindle in place on the housing 74. In another embodiment, the shaft 50 of the spindle 24 is inserted into the opening in the chuck 78, and the chuck is rotated in a clockwise direction to tighten the jaws on the shaft and secure the spindle 24, and in a counter clockwise direction to loosen the jaws relative to the shaft 50 to remove the spindle 24 from the chuck 78.

In another embodiment, a level tool, such as a bubble level, is attached to a rear surface of the housing 22, to indicate when the viscosity measurement device 20 is positioned vertically, i.e., the longitudinal axis of the housing is transverse to a horizontal plane. Specifically, the bubble level indicates to a user when the position of the viscosity measurement device is transverse to a flat surface. It should be appreciated that any suitable level tool or other level indicating device may be attached to the housing.

In a further embodiment, the control unit 60 is programmable to stop the motor after a predetermined amount of time, such as 30 seconds after the motor is activated, i.e., an automatic stop. It should be appreciated that the control unit 60 may be programmed to stop after 5 seconds, 10 seconds, 5 minutes or any suitable amount of time. In another embodiment, a light display is attached to the housing and in communication with the control unit, where the light display includes a light-emitting diode (LED) that indicates when the measured viscosity is in a predetermined range. It should be appreciated that the range may any suitable viscosity range or viscosity ranges.

While particular embodiments of the present viscosity measurement device has been described herein, it will be appreciated by those skilled in the art that changes and modifications may be made thereto without departing from the invention in its broader aspects and as set forth in the following claims.

1. A handheld viscosity measurement device comprising:
a housing including a drive shaft coupled to a motor, and a handle;
a spindle removably attached to said drive shaft;
a display device attached to said housing; and
a battery attached to said housing,
wherein the spindle is inserted in a material while the motor rotates the drive shaft and the spindle, the display device displays a measurement based on the resistance of the material on the spindle.

2. The viscosity measurement device of claim 1, wherein said spindle includes two resistance members that extend transversely to a longitudinal axis of the spindle.

3. The viscosity measurement device of claim 2, wherein said two resistance members are spaced apart along the longitudinal axis of said spindle.

4. The viscosity measurement device of claim 1, wherein said display device is mounted to a side of said housing.

5. The viscosity measurement device of claim 1, wherein said display device is mounted to an end of said housing.

6. The viscosity measurement device of claim 1, wherein said battery is a rechargeable battery.

7. The viscosity measurement device of claim 1, wherein said spindle includes a plurality of said resistance members that are spaced from each other.

8. The viscosity measurement device of claim 1, wherein said spindle includes a shaft having a first end having said resistance members and an opposing second end having a connecting member, wherein said connecting member is removably attached to said drive shaft.

9. The viscosity measurement device of claim 1, wherein said handle includes a button coupled to said motor, wherein said motor is activated when said button is pressed by a user.

10. The viscosity measurement device of claim 1, wherein said spindle is made of one of a metal or a composite material.

11. A handheld viscosity measurement device comprising:
a housing including a drive shaft coupled to a motor, a display device and a handle;
a spindle removably attached to said drive shaft;
an activation button movably attached to said housing;
a battery attached to said housing; and
a control unit inside said housing and in communication with said motor and said display device,
wherein when a user inserts the spindle in a material and presses the activation button, the control unit causes the motor to rotate the drive shaft and the spindle, detect the electrical current of the motor and display the detected current on the display device.

12. The viscosity measurement device of claim 11, wherein said spindle includes two resistance members that extend transversely to a longitudinal axis of the spindle.

13. The viscosity measurement device of claim 12, wherein said two resistance members are spaced apart along the longitudinal axis of said spindle.

14. The viscosity measurement device of claim 11, wherein said display device is mounted to a side of said housing.

15. The viscosity measurement device of claim 11, wherein said display device is mounted to an end of said housing.

16. The viscosity measurement device of claim 11, wherein said spindle includes a plurality of said resistance members that are spaced from each other.

17. The viscosity measurement device of claim 11, wherein the electrical resistance displayed on the display device is updated continuously or in intervals, and can be an immediate resistance or an average resistance over a given time, or a combination thereof.

18. The viscosity measurement device of claim 11, wherein the display device displays an electrical resistance, a motor torque or a viscosity based on the spindle used and the rotational speed of the spindle.
